(19) United States
(12) Patent Application Publication
(10) Pub. No.: US 2026/0291257 A1
(43) Pub. Date: Sep. 24, 2026

(54) INTERFACE TECHNIQUE FOR HUMANOID ROBOT IN WORK ENVIRONMENT

(71) Applicant: INTERNATIONAL BUSINESS MACHINES CORPORATION, ARMONK, NY (US)

(72) Inventors: Joseph Scaglione, Poughkeepsie, NY (US); RYAN ELSASSER, Salt Point, NY (US); Daniel Ruiz, Cold Spring, NY (US); Schuyler Mann, Poughkeepsie, NY (US)

(21) Appl. No.: 19/086,625

(22) Filed: Mar. 21, 2025

(51) Int. Cl. H02J 7/12; B25J 11/00; G06K 7/10

(52) U.S. Cl. CPC H02J 7/12; B25J 11/00; G06K 7/10297

(57) ABSTRACT

Techniques to recharge a battery of a humanoid robot operating in a work venue include aligning boots of a humanoid robot to a location on a floor in a work venue. A power receiver in the boots can be aligned to a power transmitter in the floor, and an RFID reader in the boots can be aligned to an RFID tag in the floor. Further, an electromagnet in each of the boots can be aligned to an electromagnet in the floor at the location which secures the boots to the floor in a locked position when the electromagnet is turned on.

### BACKGROUND

The present disclosure relates to connection and interface techniques, including charging, for humanoid robots in work environments.

Humanoid robots used for a variety of tasks at a variety of location and used in a plurality of situations, are increasingly popular and becoming more skilled at a variety of tasks. However, challenges exist when implementing a humanoid robot into manufacturing environments. In one example, a humanoid robot is at risk of falling/tipping over, especially when handling heavier objects, thereby posing a safety risk to humans in the area. In another example, humanoid robots typically have a limited run time. Also, humanoid robots can consume energy (for example, to run motors and sensors) and have limited battery capacities (for example, in the five to eight hour range).

### SUMMARY

The present disclosure recognizes the shortcomings and problems associated run-time limitations for a humanoid robot, and with connection and interface techniques for humanoid robots in work environments.

Embodiments of the present disclosure include a system including floor tiles and robot boots where the floor tile contains steel discs in locations and an RFID (Radio Frequency Identification) tag. In one example, a power transmission source (e.g., an inductive charger) can be used to charge the humanoid robot. The robot boots can include an electromagnet and RFID reader. In one example, power receiving hardware (e.g., an inductive coil) and power cables can be used to charge the robot. An electromagnet can be toggled on/off by the robot and is used to fixture the robot to the tile. A benefit of the present invention is the elimination of the risk of the robot falling/tipping over. Another benefit of the present invention includes the restriction of several degrees of freedom, allowing the robot to be more accurate/repeatable. In another example, a robot can lock all joints below its torso, which can extend battery life. In another example, optional power transmission and receiving hardware can be used to extend battery life in the robot’s workspace.

In an aspect according to the present invention, a method to recharge a battery of a humanoid robot operating in a work venue including aligning boots of a humanoid robot to a location on a floor in a work venue. The method includes the aligning of the boots including aligning a power receiver in the boots to a power transmitter in the floor. The method further includes the aligning of the boots further including aligning an RFID reader in the boots to an RFID tag in the floor. The method further includes the aligning of the boots further including aligning an electromagnet in each of the boots to an electromagnet in the floor at the location securing the boots to the floor in a locked position when the electromagnet is turned on.

In a related aspect, the method further comprising sending a signal to a computer, the signal being transmitted by the RFID reader.

In a related aspect, the signal is transmitted by the RFID reader using a wireless communication technique.

In a related aspect, the boots capture foot portions of the humanoid robot.

In a related aspect, the aligning of the boots is in response to the humanoid robot moving itself using battery power.

In a related aspect, the power receiver is a receiving induction coil and the power transmitter is a transmitting induction coil.

In a related aspect, the power transmitter communicates with a power source of the work venue.

In a related aspect, the aligning of the boots includes aligning a signal transmitter connector of a signal transmitter in the boots to recessed signal transmission connectors in the floor, the recessed signal transmission connectors communicating with a computer configured to receive a data transmission from the humanoid robot using the signal transmitter via the signal transmitter connector and the recessed signal transmission connector.

In a related aspect, the method further includes the robot locking articulated joints of the robot below a torso of the robot when the boots are in a locked position.

In another aspect according to embodiments of the present invention, a system to recharge a battery of a humanoid robot operating in a work venue includes boots of a humanoid robot being alignable to a location on a floor in a work venue. The system further includes a power receiver in each of the boots alignable to a power transmitter in the floor, and an RFID reader in each of the boot alignable to an RFID tag in the floor. And the system further includes an electromagnet in each of the boot alignable to an electromagnet in the floor at the location which secures the boots to the floor in a locked position when the electromagnet is turned on.

In a related aspect, the system further includes the RFID reader being configured to send a signal to a computer.

In a related aspect, the signal transmitted by the RFID reader uses a wireless communication technique.

In a related aspect, the boots capture foot portions of the humanoid robot.

In a related aspect, the alignment of the boots is in response to the humanoid robot moving itself using battery power.

In a related aspect, the power receiver is a receiving induction coil and the power transmitter is a transmitting induction coil.

In a related aspect, the power transmitter is communicable with a power source of the work venue.

In a related aspect, the boots are alignable with a signal transmitter connector of a signal transmitter in the boots to a recessed signal transmission connector in the floor, the recessed signal transmission connector communicable with a computer configured to receive a data transmission from the humanoid robot using the signal transmitter via the signal transmitter connector and the recessed signal transmission connector.

In a related aspect, the system further includes the robot having articulated joints being lockable below a torso of the robot when the boots are in a locked position.

In another aspect according to an embodiment of the present invention, a computer system for recharging a battery of a humanoid robot operating in a work venue including a processor set, a computer-readable storage medium, and program instructions stored on the computer-readable storage medium to cause the processor set to perform operations comprising: aligning boots of a humanoid robot to a location on a floor in a work venue; the aligning of the boots including aligning a power receiver in the boots to a power transmitter in the floor; the aligning of the boots further including aligning an RFID reader in the boots to an RFID tag in the floor; and the aligning of the boots further including aligning an electromagnet in each of the boots to an electromagnet in the floor at the location securing the boots to the floor in a locked position when the electromagnet is turned on.

In a related aspect the computer system further comprising sending a signal to a computer, and the signal being transmitted by the RFID reader.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram of a system to recharge a battery of a humanoid robot operating in a work venue where the humanoid robot includes boots with a charging mechanism which mates with a charging mechanism in a floor space beneath a floor surface.

FIG. 2 is a schematic block diagram of the system shown in FIG. 1 further depicting a controller for components of the system.

FIG. 3 is a schematic block diagram of a system to recharge a battery of a humanoid robot operating in a work venue including the systems shown in FIGS. 1 and 2 communicating with a control system via a communications network.

FIG. 4 is a flow chart depicting a method to recharge a battery of a humanoid robot operating in a work venue.

FIG. 5A is a schematic block diagram of system to recharge a battery of a humanoid robot shown in FIGS. 1, 2, and 3, operating in a work venue according to an embodiment of the present disclosure including an alternative charging coupling technique.

FIG. 5B is a schematic block diagram of a system to recharge a battery of a humanoid robot shown in FIGS. 1, 2, and 3, operating in a work venue according to another embodiment of the present disclosure including an alternative locking mechanisms in the boots of the humanoid robot which mate with recessed actuators in the floor space.

FIG. 5C is a schematic block diagram of a system to recharge a battery of a humanoid robot shown in FIGS. 1, 2, and 3, operating in a work venue according to another embodiment of the present disclosure including data transmission using signal transmission connectors in the boots of the humanoid robot mating with signal transmission connectors in the floor.

FIG. 6 is a schematic block diagram depicting a computer system according to an embodiment of the disclosure, which includes cloud computing components and functions, and which can cooperate, where applicable, with the one or more apparatuses, systems, and methods shown in the figures and described herein.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### EMBODIMENTS AND EXAMPLES

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method. It is understood that a user can be a customer, an individual, or a group of individuals, or a company or an organization.

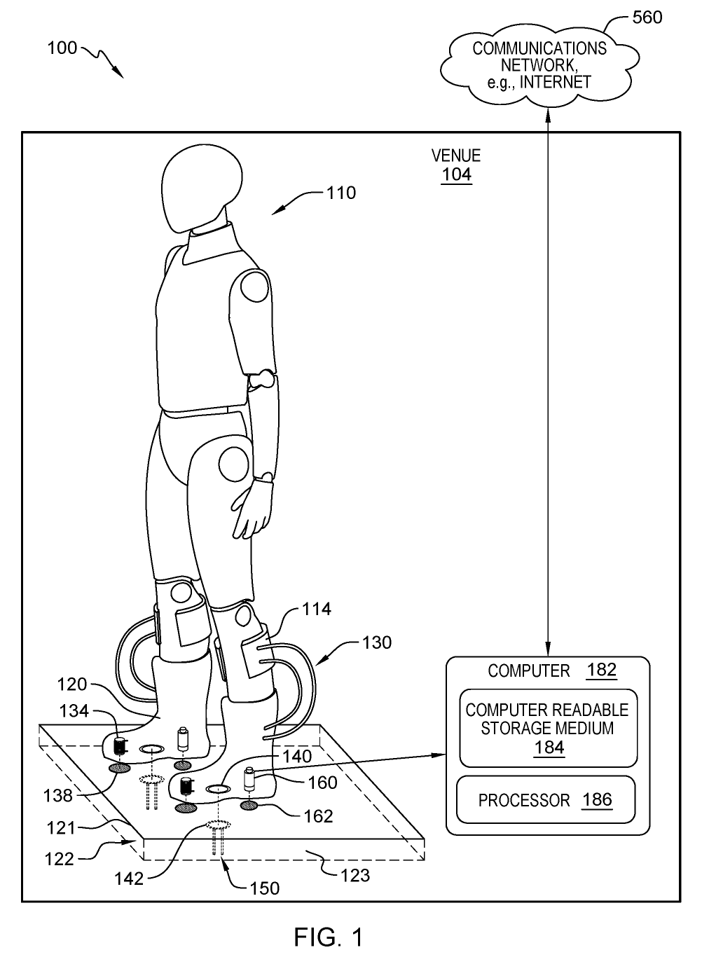

Referring to FIG. 1, a system 100 to recharge a battery 114 of a humanoid robot 110 (also referred to as the 1robot) operating in a work venue or location 104. The robot 110 includes boots 120 being part of or fitting over a foot portion of the robot. Power cables 130 connect the boot 120 to the battery 114. An electromagnet 134 is connected to the boot 120. The electromagnets 134 align with and couple to steel discs electromagnets 138 in a floor 122. The floor 122 having a floor space 123 beneath a floor surface 121. An induction coil 140 as a receiver for electrically charging the robot battery is also positioned in the boot. The receiving induction coils 140 align with and couple to the induction coils 142 for transmission of electrical current which are connected to electrical power leads 150 at the venue or facility 104. An RFID reader 160 is coupled to the boot of the robot and each of the RFID readers align with and couple to RFID tags 162 in the floor 122.

In one example, the robot 110 turns on an electromagnet 134, after aligning the boots 120 to the steel discs 138 on the floor 122 or floor surface 121 such as floor tile and reading the RFID tag 162 embedded into the floor 122.

In one example the robot can turn off the electromagnet during other operations. Optional induction charging using the inductions coils 140, 142 can extend the battery life of the robot during operation. However, other charging techniques can also be applied.

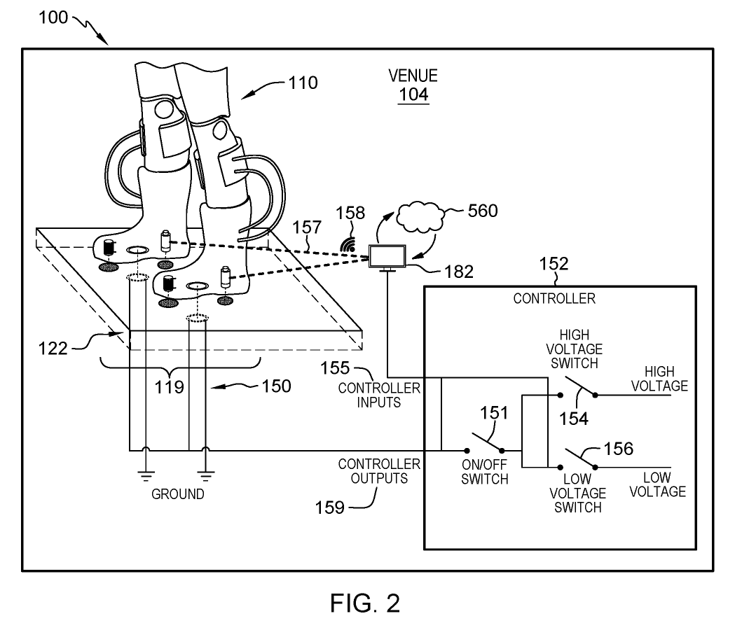

Referring to FIGS. 1 and 2, the RFID readers 160 can transmit a signal 157 to a computer 182, for example using a wireless network 560 using a wireless standard 158, such as a local area network LAN (e.g., a wireless LAN) using wireless technology. The computer 182 includes a computer readable storage medium 184 which can include one or more software programs executable by a processor 186. The computer can communicate with a communication network 560 such as the Internet to communicate with other computers or the device or computer of a remote operator. The computer 182 can also be operated or controlled by an operator 190.

Referring to FIG. 2, the system 100 further includes a controller 152, connected to or as functions implemented as part of the computer 182 for implementing control of the robot. An RFID reader 160 in the boot is used to ensure the robot is properly aligned to a floor tile by using the RFID tag 162 to capture a specific location 119 on the floor to align the electromagnets and induction coils. Once the RFID reader is aligned with the RFID tags, the robot can wirelessly transmit its own ID (identification) number (e.g., serial/model number) and a floor tile ID number for a location or specific floor tile to a facilities controller 152 that turns on power. The controller 152 can also be used to change power transmission settings (such as voltage) to accommodate different robots. The controller includes a high voltage switch 154 and a low voltage switch 156. The on/off switch 151 can be used to switch power on and off to result in an output 159. The controller can be operated using inputs 155 from the computer 182.

Thereby, the system 100 shown in FIGS. 1 and 2 depicts implementing the robot moving to a specific location on the floor and implementing RFID communication, power connections for battery recharging and locking the robot’s boot to the specific location. The robot can move itself to the specific location when it senses low power, or control can be implemented by a computer system, whether remote or local, and all or in part in conjunction with the robot’s internal controls and mechanisms for charging.

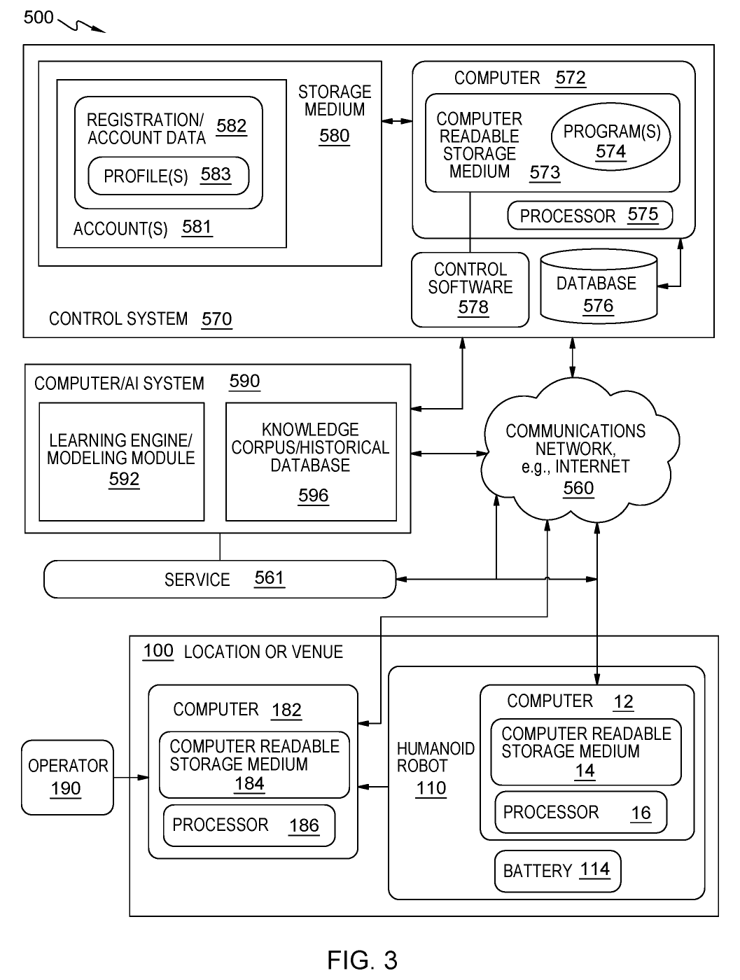

Referring to FIG. 3, a system 500 to recharge a battery of a humanoid robot operating in a work venue including the systems shown in FIGS. 1 and 2 communicating with a control system 570 via a communications network 560. In this embodiment, the robot includes a computer 12 having a computer readable storage medium 14 and a processor 16. The computer 12 can communicate with the computer 182 in the location 104, as well as communicate with the control system 570 via a communication network 560.

The system 500 includes a computer 572 which can be integral to or communicating with a device, and communicate with other computers such as the computers 12 and computer 182. A computer 590 remote from the robot can electronically communicate, in all or in part, with the control system computer 572 as part of the control system 570. The computer 590 can includes a learning engine 592, and further a knowledge corpus 596 of historical data. The control system 570 can include the computer 572 having a computer readable storage medium 573 which can store one or more programs 574 embedded on the storage medium, and a processor 575 for executing program instructions. The control system 570 can include control software 578 for managing the one or more programs. The control system can also include a storage medium which can include registration and/or account data 582 and user profiles 583 of users or entities (such entities can include robotic entities) as part of user accounts 581. User accounts 581 can be stored on a storage medium 580 which is part of the control system 570. The user accounts 581 can include registrations and account data 582 and user profiles 583. The program code can be executed by a processor 575. The computer 572 can communicate with a database 576. The control system 570 can also include a database 576 for storing all or part of such data as described above, and other data. Methods described in the various embodiments herein can also be run, in all or in part, as a service 561.

Thereby, the system 500 shown in FIG. 3 includes a computer 12 in the robot 110 which can be controlled using instruction stored on the computer 12 or executed by a remote computer 572 to guide the robot to the specific location 119 to initiate charging, etc.

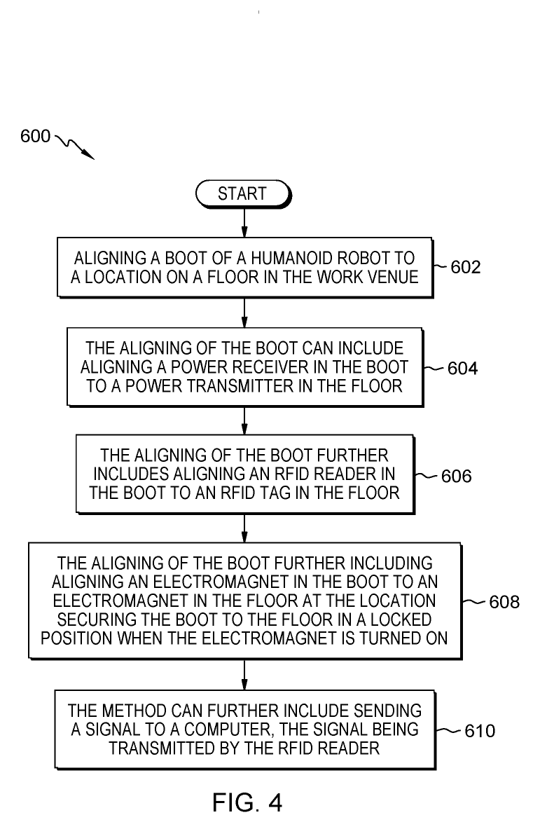

Referring to FIG. 4, a method 600 to recharge a battery 114 of a humanoid robot 110 operating in a work venue 104. The method 600 includes aligning a boot 120 of a humanoid robot 110 to a location 119 on a floor 122 in the work venue 104, as in operation 602.

The aligning of the boot 120 can include aligning a power receiver, such as a power receiving induction coil 140 in the boot to a power transmitter, such as an induction coil 142, in the floor 122, as in operation 604.

The aligning of the boot further includes aligning an RFID reader 160 in the boot to an RFID tag 162 in the floor 122, as in operation 606.

The aligning of the boot further including aligning an electromagnet 134 in the boot 120 to an electromagnet 138 in the floor 122 at the location 119 securing the boot to the floor in a locked position when the electromagnet is turned on, as in operation 608.

The method can further include sending a signal to a computer, the signal being transmitted by the RFID reader, as in operation 610.

The method can include the signal transmitted by the RFID reader to a computer using a wireless communication technique.

The method can include the boot capturing a foot portion of the humanoid robot in the boot.

In one example the aligning of the boot can be accomplished by the humanoid robot moving itself using battery power.

In another example, the power receiver can be a receiving induction coil and the power transmitter can be a transmitting induction coil

In another example, the power transmitter can communicate with a power source of the work venue.

The method can further include of claim 1, the robot locking articulated joints of the robot below a torso of the robot when the boot is in a locked position.

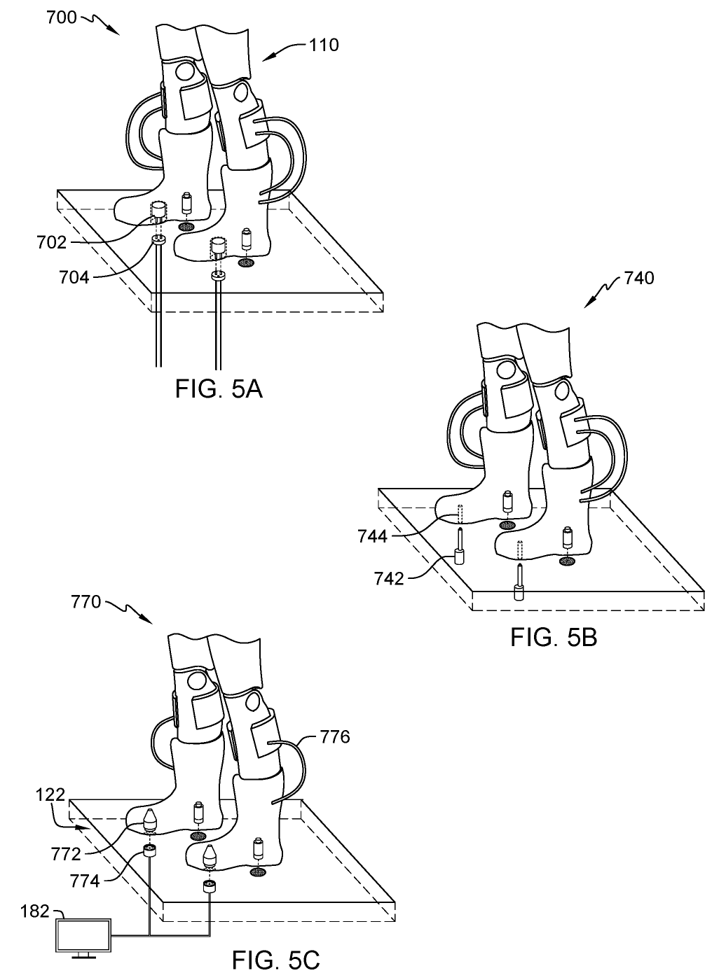

Referring to FIG. 5A, system 700 to recharge a battery of a humanoid robot shown in FIGS. 1, 2, and 3, operates in a work venue according to an embodiment of the present disclosure including an alternative charging coupling technique. Instead of inductive charging, recessed contact pads/connectors can be used to transmit power from a facilities source to the robot through the boots. For example, connectors 702 in the boots can connect with receiving connectors 704 in the floor.

Referring to FIG. 5B, a system 740 to recharge a battery of a humanoid robot shown in FIGS. 1, 2, and 3, can operate in a work venue according to another embodiment of the present disclosure and includes an alternative locking mechanisms in the boots of the humanoid robot which mate with recessed actuators in the floor space. Instead of using magnetic forces as a locking mechanism, the boots can engage/disengage from the floor surface or floor tiles using actuators or mechanical bindings. The robot can toggle the actuators via a robot-tile interface (e.g., a button/dashboard), wireless communication, or specific force (e.g., a mechanism similar to a ski binding). For example, the robot can use an actuator mating feature 744 in the boot to couple to a receded actuator 742 in the floor.

Referring to FIG. 5C, in one embodiment according to the present disclosure, a system 770 to recharge a battery of a humanoid robot shown in FIGS. 1, 2 and 3, operates in a work venue and includes aligning the boot of the robot having a signal transmitter connector 776 connecting the boot to the robot, and a signal transmitter connector 772 in the boot 120 to a recessed signal transmission connector 774 in the floor. The recessed signal transmission connector communicating with a computer 182 configured to receive a data transmission from the humanoid robot using the signal transmitter connector 776 via the signal transmitter connectors 772, 774, that is, the signal transmitter connector 772 and the recessed signal transmission connector 774.

Again, referring to FIG. 5C, the system 770 to recharge a battery of a humanoid robot shown in FIGS. 1, 2, and 3, includes data transmission using the signal transmission connectors in the boots of the humanoid robot mating with signal transmission connectors in the floor. In addition to or in place of power transmission, signals/data can be transmitted from the robot to external devices (such as compute resources) through recessed signal transmission connectors in the boot and the floor or floor tiles.

According to the present disclosure, a method of fixturing a humanoid robot with separate boots that can be dynamically/automatically engaged/disengaged to a floor tile can prevent the risk of the robot falling/tipping over while working on the floor tile. This also allows the robot to be more accurate/repeatable by eliminating several degrees of freedom. The robot can lock all joints below torso to save power and be more accurate since it does not have to control balance while engaged to the floor tile. The ability to transmit power to the robot while it is wearing the boots and working on the floor tile is also an advantage of the present disclosure. Further, on site charging extends the robot’s battery life and run time. Another advantage of the embodiment s of the present disclosure, is using inductive charging prevents dust/debris concerns on the boots and floor tiles. Another advantage of the present disclosure is the ability to modulate power (on/off) and transmission settings (voltage) based on the identification, using RFID tagging, of the floor tile or floor location and the robot. According to the present disclosure, the the robot has the ability to engage/ disengage the boots to the floor and/or floor tle using methods that include: magnetically, for example, using a digital/physical button or wireless communication; electromechanical/pneumatic/hydraulic actuators, for example, using a digital/physical button or wireless communication; and mechanically (springs and latches), for example, using specific force (e.g., unclipping a ski boot from a binding).

In one embodiment according to the present disclosure, a computer program product to recharge a battery of a humanoid robot operating in a work venue includes a computer readable storage medium; and program instructions stored on the computer readable storage medium to perform the following operations. The operations include aligning boots of a humanoid robot to a location on a floor in a work venue. The operations include the aligning of the boots including aligning a power receiver in the boots to a power transmitter in the floor. The operations include the aligning of the boots further including aligning an RFID reader in the boots to an RFID tag in the floor. And the operations include the aligning of the boots further including aligning an electromagnet in each of the boots to an electromagnet in the floor at the location securing the boots to the floor in a locked position when the electromagnet is turned on.

Thereby, according to the embodiments of the present disclosure, a method and system is provided to recharge a battery of a humanoid robot operating in a work venue. The method and system includes aligning a boot or foot portion of a humanoid robot to a location on a floor in the work venue. The method and system further includes further aligning the boot or the foot portion to a power transmission source (for example, an inductive charger) in the floor at the location. And the method and system further includes further aligning the boot or the foot portion, using an RFID reader in the boot reading an RFID tag in the floor, to an electromagnet in the floor at the location to secure the boot to the floor when the electromagnet is turned on.

Methods and systems according to embodiments of the present disclosure, can be incorporated in one or more computer programs or an application stored on an electronic storage medium, and executable by the processor, as part of the computer on mobile device. For example, a mobile device can communicate with the control system, and in another example, a device such as a video feed device can communicate directly with the control system. Other users (not shown) may have similar mobile devices which communicate with the control system similarly. The application can be stored, all or in part, on a computer or a computer in a mobile device and at a control system communicating with the mobile device, for example, using the communications network, such as the Internet. It is envisioned that the application can access all or part of program instructions to implement the method of the present disclosure. The program or application can communicate with a remote computer system via a communications network (e.g., the Internet) and access data, and cooperate with program(s) stored on the remote computer system. Such interactions and mechanisms are described in further detail herein and referred to regarding components of a computer system, such as computer readable storage media, which are shown in one or more embodiments herein and described in more detail in regards thereto referring to one or more computers and systems described herein.

Also, referring to the figures, a device can include a computer, computer readable storage medium, and operating systems, and/or programs, and/or a software application, which can include program instructions executable using a processor. Embodiments of these features are shown herein in the figures. The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

### ADDITIONAL EXAMPLES AND EMBODIMENTS

In one example, a system according to the present disclosure can include a control system communicating with a user device via a communications network. The control system can incorporate all or part of an application or software for implementing the method of the present disclosure. The control system can include a computer readable storage medium where account data and/or registration data can be stored. User profiles can be part of the account data and stored on the storage medium. The control system can include a computer having computer readable storage medium and software programs stored therein. A processor can be used to execute or implement the instructions of the software program. The control system can also include a database.

A control system can include a storage medium for maintaining a registration of users and their devices for analysis of the audio input. Such registration can include user profiles, which can include user data supplied by the users in reference to registering and setting-up an account. In an embodiment, the method and system which incorporates the present disclosure includes the control system (generally referred to as the back-end) in combination and cooperation with a front end of the method and system, which can be the application. In one example, the application is stored on a device, for example, a computer or device on location, and can access data and additional programs at a back end of the application, e.g., control system.

In one example, received data can include data in a knowledge corpus and historical database, which can be populated by historical data gathered, for example, from sensors, robotic device, or other machines or devices. In another example and embodiment, profiles can be saved for entities such as users, participants, operators, human operators, or robotic devices. Such profiles can supply data regarding the user and history of deliveries for analysis. In one example, a user can register or create an account using the control system which can include one or more profiles as part of registration and/or account data. The registration can include profiles for each user having personalized data. For example, users can register using a website via their computer and GUI (Graphical User Interface) interface. The registration or account data can include profiles for an account for each user. Such accounts can be stored on the control system, which can also use the database for data storage. A user and a related account can refer to, for example, a person, an administrator, or an operator, or an entity, or a corporate entity, or a corporate department, or another machine such as an entity for automation such as a system using, in all or in part, artificial intelligence.

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items.

In one example a user can register and have an account with a user profile on a control system. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user’s option to cancel such profile or account, and/or input of data, and thus opt-out, at the user’s discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user’s authorization and consent.

In one or more embodiments of the present invention, a user(s) can opt-in or register with a control system, voluntarily providing data and/or information in the process, with the user’s consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### OTHER ADDITIONAL EMBODIMENTS AND EXAMPLES

It is also understood that methods and systems according to embodiments of the present disclosure, can be incorporated into (Artificial Intelligence) AI devices, components or be part of an AI system, which can communicate with respective AI systems and components, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

The methods and systems of the present disclosure can include a series of operational blocks for implementing one or more embodiments according to the present disclosure. A method shown in the figures may be another example embodiment, which can include aspects/operations shown in another figure and discussed previously, but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is also understood that the one or more computers or computer systems shown in the figures can include all or part of a computing environment and its components shown in another figure, for example, the computing environment 1000 can be incorporated, in all or in part, in one or more computers or devices shown in other figures and described herein, or vice versa. In one example, the one or more computers can communicate with all or part of a computing environment and its components as a remote computer system to achieve computer functions described in the present disclosure.

### MORE ADDITIONAL EXAMPLES AND EMBODIMENTS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

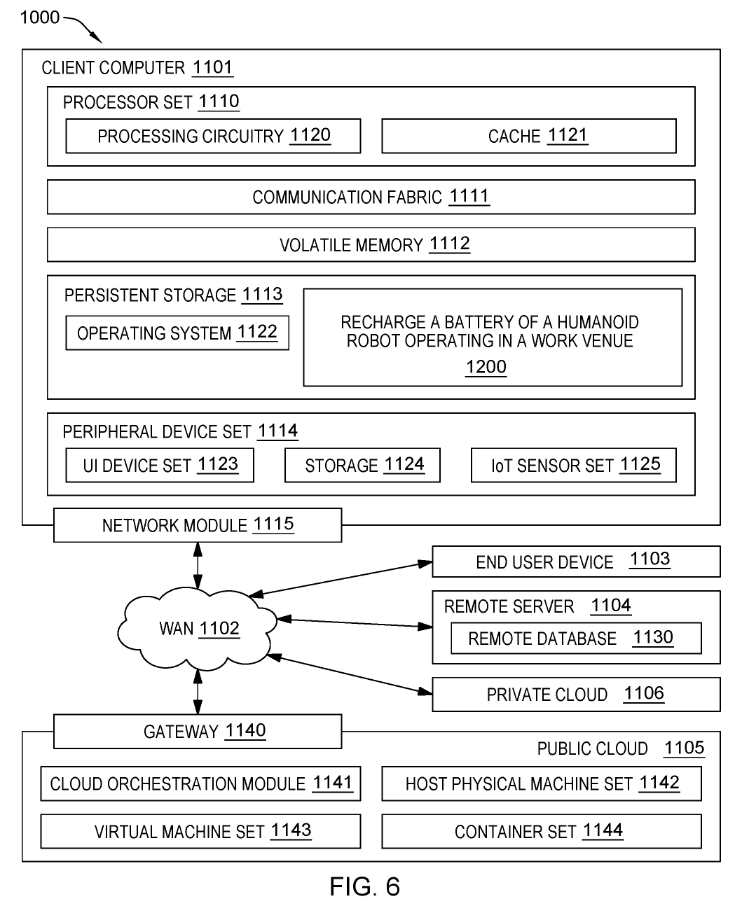

Referring to FIG. 6, a computing environment 1000 contains an example of an environment for the execution of at least some of the computer code involved in performing the inventive methods, such as recharging a battery of a humanoid robot operating in a work venue 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1101, to keep the presentation as simple as possible. Computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1000, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

What is claimed is:

1. A method to recharge a battery of a humanoid robot operating in a work venue; comprising:
aligning boots of a humanoid robot to a location on a floor in a work venue;
the aligning of the boots including aligning a power receiver in the boots to a power transmitter in the floor;
the aligning of the boots further including aligning an RFID reader in the boots to an RFID tag in the floor; and
the aligning of the boots further including aligning an electromagnet in each of the boots to an electromagnet in the floor at the location securing the boots to the floor in a locked position when the electromagnet is turned on.

2. The method of claim 1, further comprising:
sending a signal to a computer, the signal being transmitted by the RFID reader.

3. The method of claim 2, wherein the signal being transmitted by the RFID reader using a wireless communication technique.

4. The method of claim 1, wherein the boots capture foot portions of the humanoid robot.

5. The method of claim 1, wherein the aligning of the boots is in response to the humanoid robot moving itself using battery power.

6. The method of claim 1, wherein the power receiver is a receiving induction coil and the power transmitter is a transmitting induction coil.

7. The method of claim 1, wherein the power transmitter communicates with a power source of the work venue.

8. The method of claim 1, wherein the aligning of the boots includes aligning a signal transmitter connector of a signal transmitter in the boots to recessed signal transmission connectors in the floor, the recessed signal transmission connectors communicating with a computer configured to receive a data transmission from the humanoid robot using the signal transmitter via the signal transmitter connector and the recessed signal transmission connector.

9. The method of claim 1, further comprising:
the robot locking articulated joints of the robot below a torso of the robot when the boots are in a locked position.

10. A system to recharge a battery of a humanoid robot operating in a work venue, which comprises:
boots of a humanoid robot being alignable to a location on a floor in a work venue;
a power receiver in each of the boots alignable to a power transmitter in the floor;
an RFID reader in each of the boot alignable to an RFID tag in the floor; and
an electromagnet in each of the boot alignable to an electromagnet in the floor at the location which secures the boots to the floor in a locked position when the electromagnet is turned on.

11. The system of claim 10, further comprising:
the RFID reader being configured to send a signal to a computer.

12. The system of claim 11, wherein the signal transmitted by the RFID reader uses a wireless communication technique.

13. The system of claim 10, wherein the boots capture foot portions of the humanoid robot.

14. The system of claim 10, wherein the alignment of the boots is in response to the humanoid robot moving itself using battery power.

15. The system of claim 10, wherein the power receiver is a receiving induction coil and the power transmitter is a transmitting induction coil.

16. The system of claim 10, wherein the power transmitter is communicatable with a power source of the work venue.

17. The system of claim 10, wherein the boots are alignable with a signal transmitter connector of a signal transmitter in the boots to a recessed signal transmission connector in the floor, the recessed signal transmission connector communicatable with a computer configured to receive a data transmission from the humanoid robot using the signal transmitter via the signal transmitter connector and the recessed signal transmission connector.

18. The system of claim 10, further comprises:
the robot having articulated joints being lockable below a torso of the robot when the boots are in a locked position.

19. A computer system for recharging a battery of a humanoid robot operating in a work venue, comprising:
a processor set, a computer-readable storage medium, and program instructions stored on the computer-readable storage medium to cause the processor set to perform operations comprising:
aligning boots of a humanoid robot to a location on a floor in a work venue;
the aligning of the boots including aligning a power receiver in the boots to a power transmitter in the floor;
the aligning of the boots further including aligning an RFID reader in the boots to an RFID tag in the floor; and
the aligning of the boots further including aligning an electromagnet in each of the boots to an electromagnet in the floor at the location securing the boots to the floor in a locked position when the electromagnet is turned on.

20. The computer system of claim 19, further comprising:
sending a signal to a computer, and the signal being transmitted by the RFID reader.
